(19) United States
(12) Patent Application Publication
(10) Pub. No.: US 2019/0188660 A1
(43) Pub. Date: Jun. 20, 2019

(54) PAYMENT APPARATUS AND METHOD FOR ENABLING A PAYMENT DEVICE FOR REMOTELY ACCESSING A TRANSACTION

(71) Applicant: MASTERCARD INTERNATIONAL INCORPORATED, Purchase, NY (US)

(72) Inventors: Gaurav K. Patni, Pune (IN); Ketan Shrikant Joshi, Pune (IN)

(21) Appl. No.: 16/194,752

(22) Filed: Nov. 19, 2018

(30) Foreign Application Priority Data
Dec. 19, 2017 (SG) 10201710579R

(51) Int. Cl. G06Q 20/10; G06Q 20/32; G06Q 20/38; G06Q 20/20

(52) U.S. Cl. CPC G06Q 20/102; G06Q 20/204; G06Q 20/387; G06Q 20/3223

(57) ABSTRACT

According to the first aspect, there is provided a payment apparatus for enabling a payer device for effecting a transaction, the payer device operationally communicable with the apparatus, the payment apparatus comprising: at least one processor; and at least one memory including computer program code; the at least one memory and the computer program code configured to, with the at least one processor, cause the apparatus at least to: receive, from the payer device, a request to remotely access the transaction, the request including user information verifying the user; enable the payer device to remotely control the transaction in response to receiving the request; receive account information that is remotely input via the payer device, the account information relating to an account to be used for the transaction.

### CROSS-REFERENCE TO RELATED APPLICATION

This application claims the benefit of and priority to Singapore Patent Application No. 10201710579R filed Dec. 19, 2017. The entire disclosure of the above application is incorporated herein by reference.

### FIELD

The present disclosure relates broadly, but not exclusively, to apparatuses and methods for enabling a payer device for remotely accessing a transaction which is made possible by a payment apparatus sharing its screen with the payer device.

### BACKGROUND

This section provides background information related to the present disclosure which is not necessarily prior art.

Small and medium businesses in many countries face significant challenges in adapting to, and taking advantage of, an increasingly networked world. The Internet has opened up new opportunities and challenges for retailers to better service their customers. The Internet can provide a vehicle for customers to place orders online. Online purchases provide customers with promotions (e.g., interest-free repayment schemes), comfort and security, knowing that bystanders will not be able to view their passwords. In stark contrast, customers are required to key in their passwords at point-of-sale (POS) devices or payment apparatuses, having to worry that other bystanders will be able to view their passwords as they key in the passwords.

The conventional POS devices only allow one customer to make payment at any point in time. This often makes the shopping experience slow and frustrating. While it may be possible to solve this problem by providing more POS devices at the retail premise, such shop space is typically out of reach for many small and medium businesses from a cost standpoint. Moreover, for customers to key in their passwords at the POS device, may not seem to be secure because customers standing behind them may be able to view these passwords.

A need therefore exists to provide apparatuses and methods for enabling a payer device for remotely accessing a transaction that addresses one or more of the above problems.

Furthermore, other desirable features and characteristics will become apparent from the subsequent detailed description and the appended claims, taken in conjunction with the accompanying drawings and this background of the disclosure.

### SUMMARY

This section provides a general summary of the disclosure, and is not a comprehensive disclosure of its full scope or all of its features. Aspects and embodiments of the disclosure are set out in the accompanying claims.

According to the first aspect, there is provided a payment apparatus for enabling a payer device for effecting a transaction, the payer device operationally communicable with the apparatus, the payment apparatus comprising: at least one processor; and at least one memory including computer program code; the at least one memory and the computer program code configured to, with the at least one processor, cause the apparatus at least to: receive, from the payer device, a request to remotely access the transaction, the request including user information verifying the user; enable the payer device to remotely control the transaction in response to receiving the request; receive account information that is remotely input via the payer device, the account information relating to an account to be used for the transaction.

According to the second aspect, there is provided a method for enabling a payer device for effecting a transaction, the method comprising receiving, from the payer device, a request to remotely access the transaction, the request including user information verifying the user; enabling, the payer device, to remotely control the transaction in response to receiving the request; and receiving account information that is remotely input via the payer device, the account information relating to an account to be used for the transaction.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments and implementations are provided by way of example only, and will be better understood and readily apparent to one of ordinary skill in the art from the following written description, read in conjunction with the drawings, in which:

FIGS. 1A and 1B show block diagrams of a system within which a payment apparatus may enable a payer device for effecting a transaction according to various embodiments.

FIG. 2 shows a flow diagram illustrating a method for enabling a payer device for effecting a transaction according to various embodiments.

FIG. 3 shows a schematic diagram of a computer system suitable for use in executing the method depicted in FIG. 2 according to various embodiments.

FIG. 4 shows an exemplary computing device used to realize the payment apparatus according to various embodiments.

FIG. 5 depicts an exemplary computing device used to realize the payment network server according to various embodiments.

FIG. 6 (PRIOR ART) shows a block diagram of a system 600 within which a payment apparatus may be used for effecting a transaction according to conventional technique.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

### Overview

Various embodiments provide payment apparatuses and methods for enabling a payer device for remotely accessing a transaction. That is, various embodiments can provide a payment apparatus sharing its screen with the payer device, and using the payer device's keyboard or touchscreen functionality to enter the password and/or other instructions. An interface between the payer transaction application on the payer device displays the screen of the payment device.

Advantageously, with the devices and methods according to various embodiments, it is made possible for transactions to be remotely accessed via a payer device at a payment apparatus.

### Terms Description (in Addition to Plain and Dictionary Meaning of Terms)

A payer transaction module is an application associated with a transaction function, e.g., shopping, and may be one that supports payment to settle the transaction. For example, the payer transaction module may be an extension of an existing payment module, e.g., Masterpass®, which is a digital payment service from Mastercard® that provides fast, simple and secure digital payments across devices and channels. Alternatively, the payer transaction module is one, separate from the payment module that supports a switch to the payment module to settle the transaction at an appropriate stage of the transaction. The payer transaction module is one that may be used at the premise of a payee who is a registered user of the payee transaction module. In other words, the payer transaction module is one that can be used at the premise of one or more payees.

A payee transaction module is an application that is associated with a payee (who is a registered user like a merchant), and may be one that supports additional services like payment to settle a transaction or scanning service.

A payment network server typically is associated with a payment facilitator. For example, the payment network server may be the Banknet® network operated by Mastercard®. The payment facilitator (e.g. Mastercard®) may be an entity (e.g. a company or organization) who operates to process transactions, clear and settle funds for payments between two entities (e.g. two banks). The payment network server may include one or more computing devices that are used for processing transactions. In specific implementations, the payment network server is further configured to perform additional operations. For example, the payment network server may be configured to update the database whenever a user (e.g., a payer or a payee) registers for a module (e.g., a payer shopping mobile application or a payee shopping mobile application). Additionally, the payment network server may also be configured to determine if a payer is one who is permitted to remotely control a transaction request.

A payment account is one that can be used by a consumer (or a payer) for a transaction with a merchant (or a payee). A payment account may include a payment card. In the following description, the term “payment card” refers to any suitable transaction card such as a credit card, debit card, prepaid card, charge card, membership card, promotional card, frequent flyer card, identification card, gift card, and/or one that is stored in any other device such that the device may hold payment account information such as a PAN of the payment card. Such devices can include mobile phones, smartphones, personal digital assistants (PDAs), key fobs, and/or computers. Each type of these devices can be used as a method of payment for performing a transaction with a POS terminal (or payment apparatus) of the merchant.

A POS terminal or a payment apparatus is an electronic device that can be used to process card payments at retail locations such as a merchant store. For example, when a payment card is presented at the payment apparatus for making a transaction, the payment apparatus reads information off a consumer's (or payer's) payment card and determines whether the payer is one who is permitted to remotely control the payment transaction. When it is determined that the payer is one who is permitted to remotely control the payment transaction, the payment apparatus enables the payer device to remotely control the payment transaction. The checking and transfer of funds is typically done via communication with a payment network server.

Embodiments will now be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “analysing”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the method(s) herein.

In embodiments of the present disclosure, use of the term ‘server’ may mean a single computing device or at least a computer network of interconnected computing devices which operate together to perform a particular function. In other words, the server may be contained within a single hardware unit or be distributed among several or many different hardware units.

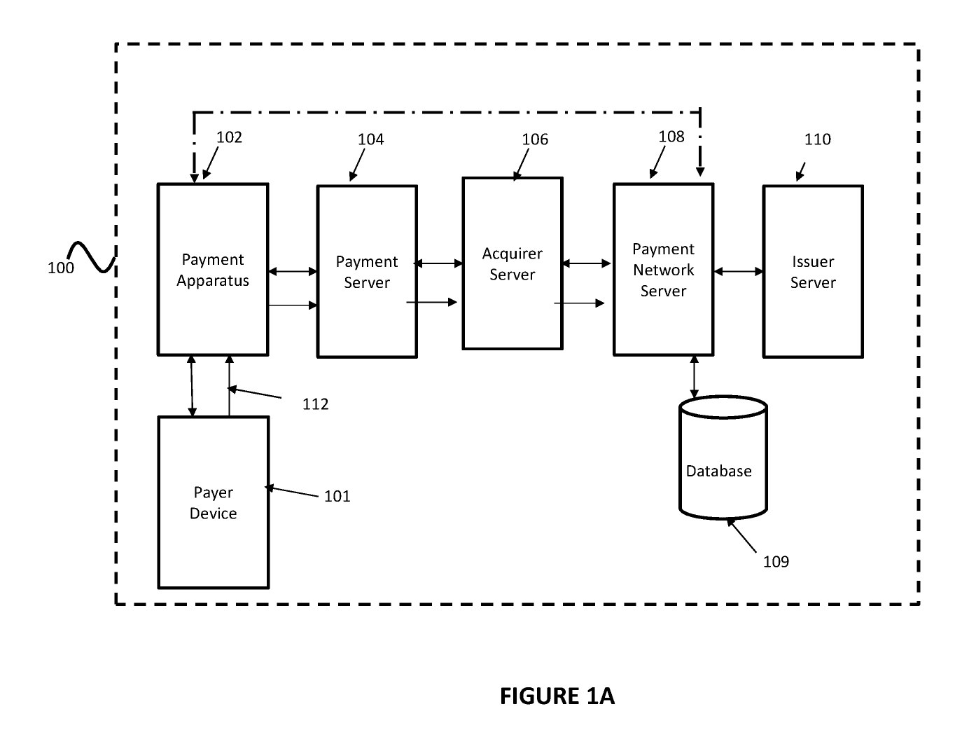

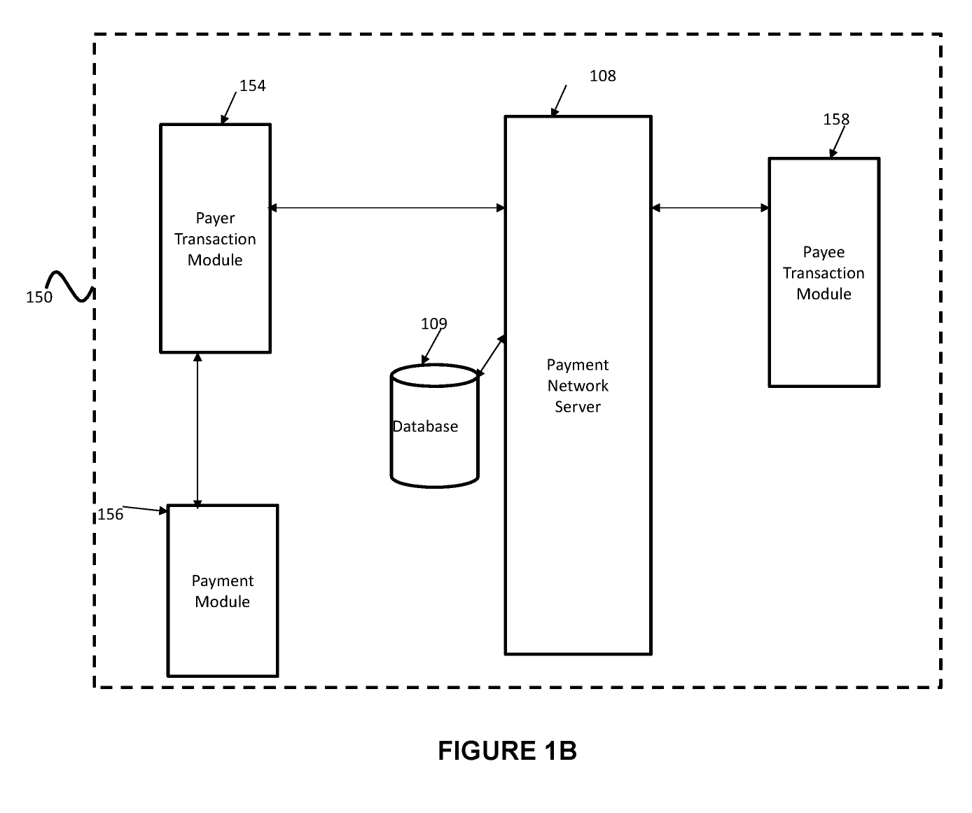

FIG. 1A illustrates a block diagram of a transaction system 100 within which transaction data can be received.

The system 100 comprises a payer device 101 in communication with a payment apparatus 102. The payment apparatus 102 may also be in direct communication with a payment network server 108, without having to communicate with the payment server (or POS server) 104. That is, the payment apparatus 102 may be a payment server 104.

The payment server 104 is in communication with an acquirer server 106. The acquirer server 106, in turn, is in communication with the payment network server 108. The payment network server 108, in turn, is in communication with an issuer server 110.

The payer device 101 typically is associated with a customer (or payer) who is a party to a transaction that occurs between the payer device 101 and the payment apparatus 102. The payer device 101 may be a wireless (portable) computing device. In specific implementations, the payer device 101 may be a mobile device, such as a mobile phone, a laptop computer, a personal digital computer (PDA), a mobile computer, a portable music player (such as an iPod™ and the like).

The payment apparatus 102 typically is associated with the merchant who is also a party to the transaction that occurs between the payer device 101 and the payment apparatus 102 through the transaction. The payment apparatus 102 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

In various embodiments, payment apparatus 102 may be used for merchant-operated, consumer-facing and self-service payment systems adapted for use in various industries, namely financial, retail, hospitality, petroleum, government and healthcare industries. Payment solutions comprise payment apparatuses that run their own operating systems, security and encryption software, and are typically located at the merchants for transmitting consumer-initiated transaction requests to the relevant parties. For example, where payment cards or digital wallets are used, the payment apparatus 102 may typically forward the consumer-initiated transaction requests to the payment facilitators facilitating the payment cards or digital wallets.

The payment server 104 typically is associated with an entity who manages the payment apparatus 102. That is, the payment server 104 may be one configured to operate with the payment apparatus 102 which may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

The acquirer server 106 generally is associated with an acquirer who may be an entity (e.g., a company or organization) which issues (e.g., establishes, manages, administers) a transaction credential or an account (e.g., a financial bank account) of the merchant. Examples of the acquirer include a bank and/or other financial institution. As stated in the above, the acquirer server 106 may include one or more computing devices that are used to establish communication with another server by exchanging messages with and/or passing information to the other server.

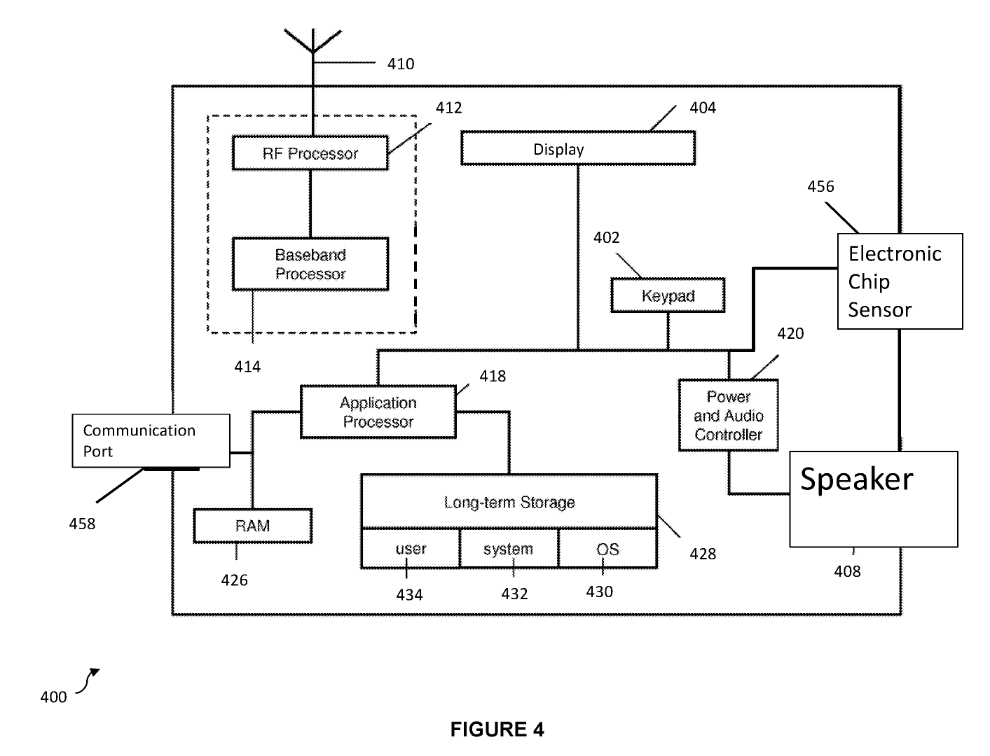

The payment network server 108 typically is associated with a payment facilitator. For example, the payment network server 108 may be the Banknet® network operated by Mastercard®. The payment facilitator (e.g., Mastercard®) may be an entity (e.g., a company or organization) who operates to process transactions, clear and settle funds for payments between two entities (e.g., two banks). The payment network server 108 may include one or more computing devices that are used for processing transactions. An exemplary payment network server 108 is shown in FIG. 4.

The issuer server 110 generally is associated with an issuer and may include one or more computing devices that are used to perform a payment transaction. The issuer may be an entity (e.g., a company or organization) which issues (e.g., establishes, manages, administers) a transaction credential or an account (e.g., a financial bank account). An account may be associated with a plurality of payer devices 101. That is, a payer may use a plurality of payer devices including, among other things, his mobile phone, his PDA and his laptop to utilize his account.

The payment network server 108 may be configured to communicate with, or may include, a database (or a transaction database) 109. The transaction database 109 stores data corresponding to a transaction (or transaction data). Examples of the data include Transaction ID, Merchant ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant, time and date for which the goods/services relating to the transaction will be delivered, and a corresponding delivery option that has been utilized.

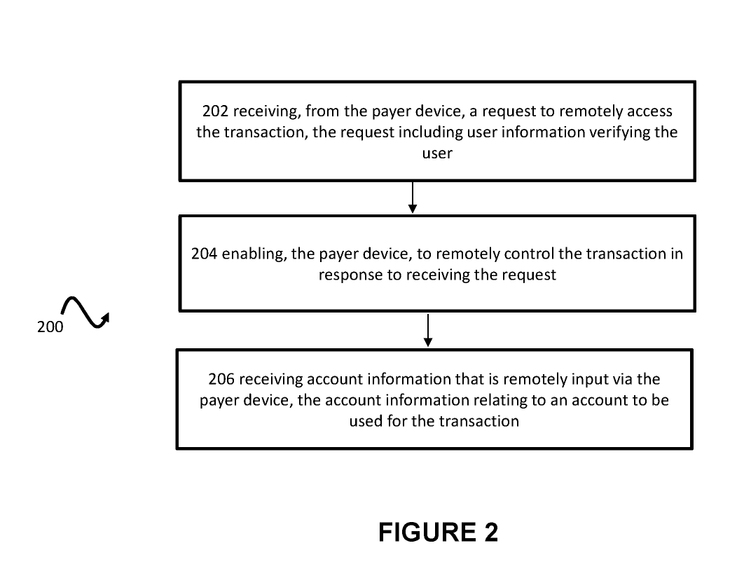

In specific implementations, the payment network server 108 is further configured to perform additional operations. For example, the payment network server 108 may be configured to update the database 109 whenever a user (e.g., a payer or a payee) registers for a module (e.g., a payer shopping mobile application or a payee shopping mobile application). Additionally, the payment network server 108 may also be configured to determine if a payee is available to carry out a transaction for which the transaction request may be remotely accessed by a payer device 101. Similarly, the payment network server 108 may also determine if a payer is permitted to remotely control a transaction request for effecting a transaction. Further details on how this data is managed are described in FIG. 2 below.

The payer device 101 is capable of wireless communication using a suitable protocol with the payment apparatus 102. For example, embodiments may be implemented using payer devices 101 that are capable of communicating with Wi-Fi/Bluetooth-enabled payment apparatuses 102. It will be appreciated by a person skilled in the art that depending on the wireless communication protocol used, appropriate handshaking procedures may need to be carried out to establish communication between the payer device 101 and the payment apparatus 102. For example, in the case of Bluetooth communication, discovery and pairing of the payer device 101 and the payment apparatus 102 may be carried out to establish communication at the premise of the merchant (or payee).

In an example, during a transaction, a transaction request (or transaction request message) 112 is generated at the payer device 101. The transaction request message 112 is generated by the payer device 101 in response to the customer (or payer) making a selection of a good and/or service (or a product) to be purchased from the merchant (or payee). In other words, the transaction request message 112 relates to a transaction between the payer and the payee, typically at the merchant's retail location (or the payee location). The transaction may be performed via a payer transaction module 154 and/or a payment module 156 as shown in FIG. 1B (or a payer transaction module) that works with the infrastructure of the payee. In specific implementations, the payer device 101 may be fitted with a wireless communications interface such as a Near Field Communication (NFC) interface to enable the payer device 101 to electronically communicate with the payment apparatus 102 to perform the transaction. NFC is a set of standards to establish radio communication between devices by bringing them into close proximity such as only a few centimetres. NFC standards cover communication protocols and data exchange formats, and are based on radio-frequency identification (RFID) technology.

The transaction request message 112 may include an account identifier identifying a user, user data, a type of transaction and transaction data. For example, a payer may scan a QR code on a product. The payer may fill in the account identifier and the transaction data (or details). The account identifier may refer to various types of accounts that are administered by one or more issuers, which can be used by the payer. The payer data may include the name of the user and the date of expiry of the account (if applicable).

In other words, each transaction data relates to a transaction and identifies the payer and the payee, generally by way of identifiers of each associated with the payer and the payee respectively. Further, the transaction data may also identify the good and/or service to be purchased and a type or nature of the transaction. The transaction data may further identify a value or price of the good and/or service (e.g., a product). The transaction data may also indicate a time and date at which the transaction was initiated by the payer.

As mentioned above, the role of the payment network server 108 is to facilitate communication between the payment server 104 and another server (e.g., an issuer server). Therefore, the payment network server 108 may serve as a means through which the payment server 104 may communicate with the issuer server 110 in a manner that messages may be accepted and forwarded.

Additionally, an intermediary interface system may be situated, between the payer device 101 and the payment apparatus 102. Although the description illustrated utilizes a payer device 101 and a payment apparatus 102, it should be understood that a plurality of the payer device 101 are contemplated within examples of the disclosure.

FIG. 1B shows a block diagram 150 within which a payment network server 108 for processing a transaction request using a payer transaction module (or a payer transaction application) 154 that is configured to communicate with a payee transaction module (or a payee transaction application) 158, managed by a payment server 104. The payment network server 108 includes a processor configured to ensure that the payment server 104 gets updates on payers who are permitted to remotely access the transaction request. Advantageously, this ensures that the payer, once permitted to remotely access the transaction, will be able to enter his confidential information like password on the payer device 101, without having to worry about other people seeing it at the payment apparatus 102. That is, various embodiments can provide a payment apparatus 102 sharing its screen with the payer device 101, and using the payer device's keyboard or touchscreen functionality to enter the password and/or other instructions. An interface between the payer transaction application on the payer device displays the screen of the payment device.

The payment network server 108 is configured to receive, from an issuer server 110, an update if a payer or a group of payers are permitted to remotely access a transaction request. In other words, the payment network server 108 is one that is operatively communicable with one or more issuer servers.

In response to an update of the database 109, the payment network server 108 may be configured to send a notification message informing the payment server 104 of the update on the database 109 of the message.

In various embodiments, the payer application 154 (which may be executing on a payer device 101) may be configured to receive information relating to the payer. The payer application 154 may be configured to receive information relating to the payer via NFC or similar connection. The information will then be forwarded to the payment server 104 which is one configured to access a database 109 that is updatable by a payment network server 108.

In an embodiment, the payment server 104 is one that is configured to identify a payer and/or payee corresponding to an account indicated in the transaction request message 112. The payment server 104 may also be configured to determine if a payer is permitted to remotely access a transaction request by retrieving relevant information from the database 109. This may be done by retrieving information from the database 109 to determine if the payer is one who is subscribed to a service which allows the payer to remotely access the transaction.

The database 109 is one that is updated by the payment network server 108 whenever an issuer server sends a notification message informing that an issuer is having a promotion for an account or a plurality of accounts. Hence, the payment server 104 may retrieve information from the database 109 to determine if the issuer identified in the transaction request is one that has informed the payment network server 108 that it is going to offer an offer or promotion. For example, if the identified issuer is one that matches the retrieved information from the database 109, it is one that is offering an on-going offer. This may be referred to as an offline check because the payment server 104 may be configured to conduct this check without being in an active internet communication with the payment network server 108.

In response to the determination of whether the identified issuer is having an offer for the account identified in the transaction request, the payment server 104 may forward information including account details of the account indicated in the transaction request message and issuer detail of the identified issuer to the payment network server 108 via the payment network application 154. This may be sent in a manner of a promotion request to the payment network server 108, requesting to participate in a promotion corresponding to the identified issuer. For example, if the payment server 104 determines that the identified issuer is offering a promotion in the offline check, it may send a promotion request to the payment network server 108 when it is in internet communication with the payment network server 108.

Advantageously, this real time updating of the payment server 104 is not limited to a specific issuer. Typically, the payment network server 108 facilitates transactions between acquirers and issuers and is configured to receive information relating to the transactions (e.g., promotions by issues). On the other hand, the payment server 104 is one that facilitates payment for a merchant and is not configured to receive information relating the issuers. In order for conventional POS server to receive updated information relating to issuer, it requires updating of the existing software and/or hardware of the payment server 104. Even so, it may be limited to specific issuers, depending on the updates.

Additionally, the payment network server 108 may be configured to determine if the account indicated in the promotion request is permitted to participate in the promotion based on predetermined criteria. While the payment server 104 may determine if the identified issuer is one that is offering a promotion, it may not be configured to determine if the account to be used for the transaction is one that is eligible for the promotion. The predetermined criteria refer to conditions determined by at least one entity (e.g., an issuer) under which an account may be used for a promotion. The determination may be performed in response to a credibility score, reliability score or confidence score relating to the account based on historical transaction data. Additionally or alternatively, the determination may also be performed based on the type of the account. e.g., whether it corresponds to one having a specific net worth (e.g., a saving account having an amount higher than a predetermined amount).

In response to the determination if the account indicated in the promotion request is permitted to participate in the promotion, the payment network server 108 may send, to the payment server 104, a payment approval message approving the promotion request when it is determined that the account indicated in the promotion request is permitted to participate in the promotion. Additionally, the payment network server 108 may send, to the payment server 104, a payment denial message denying the promotion request when it is determined that the account indicated in the promotion request is not permitted to participate in the promotion.

In other words, the payment server 104 is configured to receive, from the payment network server 108, a payment approval message approving the promotion request indicating that the account indicated in the promotion request is permitted to participate in the promotion. In response to the receipt of the payment approval message, the payment server 104 may be configured to send, to the payment apparatus 102, the promotion in response to receiving the payment approval message. In other words, the payer may now have an option to participate in a promotion that is being offered by an issuer who has issued his account. Conventionally, a payer who uses a payer device 101 to make payment will not be available to enjoy such promotions. Examples of the promotion include, among other things, an interest-free repayment installment. These promotions may be provided by the issuer or the payment facilitator.

The payment apparatus 102 may receive, a transaction receipt in response to an approval of transaction, the transaction receipt indicating at least a name of a product and a corresponding transaction amount of the product. Additionally or alternatively, the transaction receipt may be sent to the payer device.

Additionally, an intermediary interface system may be situated, between the payer device 101 and the payment apparatus 102. Although the description illustrated utilizes a payer device 101 and a payment apparatus 102, it should be understood that a plurality of the payer device 101 and the payment apparatus 102 are contemplated within examples of the disclosure. The payer device 101 is configured to communicate via Wi-Fi, Bluetooth, NFC, USB, hard wire, or other known or to be developed communications means, to the payment apparatus 102, providing remote access and control of the payment apparatus 102 at the payee location by remote representative system, even when the payment apparatus has no connectivity to a network (the Internet, a LAN, etc.) using its built-in or otherwise normal network communication approaches.

Such a server may be used to implement the method 200 shown in FIG. 2. FIG. 2 shows a flowchart illustrating a method 200 for enabling a payer device 101 for effecting a transaction with embodiments of the disclosure. The method 200 can be used to allow at least one payer device 101 to remotely control the transaction.

Referring to FIG. 2:

At step 202: receiving, from the payer device, a request to remotely access the transaction, the request including user information verifying the user.

At step 204: enabling, the payer device, to remotely control the transaction in response to receiving the request.

At step 206, receiving account information that is remotely input via the payer device, the account information relating to an account to be used for the transaction.

At step 204, for the purposes of enabling, the payer device, to remotely control the transaction in response to receiving the request in step 202, the method comprises authentication information authenticating if the user using the payer device is an owner of the account. This could be comparing an input received from the user to a password that corresponds to the owner of the account. The password may be one that is provided during registration of the account and may be stored in a database 109. The authentication information may be provided in a manner of a remote input signal, for example, via a keypad on a payer device.

At step 206, for the purposes of receiving account information that is remotely input via the payer device, the account information relating to an account to be used for the transaction, the method comprises wirelessly receiving, from the payer device, a remote input signal when enabling the payer device to remotely control the transaction. The remote input signal may be provided in a manner of, for example, via a keypad on a payer device. Subsequent to receiving the account information, the payment network server identifies an issuer issuing the account based on the account information and retrieves information from a database to determine if the issuer is having an offer for the account. In the event that there is an offer, the method may comprise receiving, from a payment network server, an offer available to the payer; and forwarding, to the payer device, the offer. In the event that the payer would like to use the offer, the method may comprise receiving, from the payer device, a request to utilize the offer available to the payer.

Subsequent to receiving the request to utilize the offer available to the payer, the method may comprise facilitating payment for the transaction. On the other hand, if the payer does not want to utilise the office, the method may comprise facilitating payment for the transaction, without receiving the request to utilize the offer.

The above steps of the method may be performed when the payer device is not in internet communication with a payment apparatus. For example, the method may comprise the request to remotely access the transaction received from the payer device when the payer device is not in internet communication with a payment apparatus. It is to be appreciated while it is mentioned in the above that a payer device may remotely access the transaction on the payment apparatus, it is possible for a further payer device to receive, from a further payer device, a further request to remotely access a further transaction initiated by the further payer device, the further request being one that is received while the payment apparatus is enabling the further payer device to remotely control the further transaction.

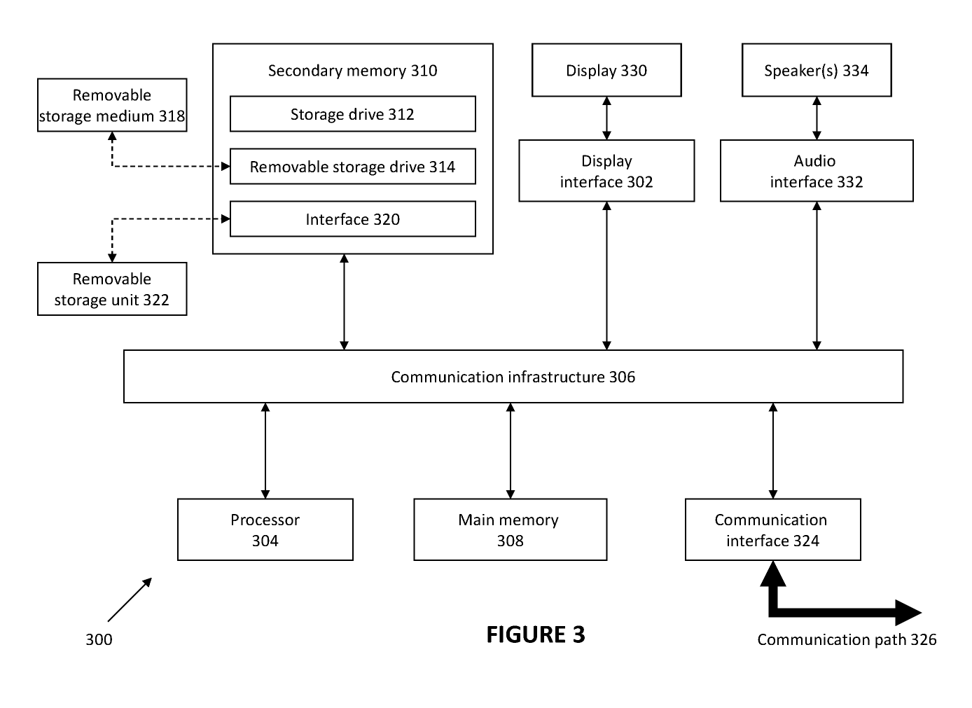

FIG. 3 depicts an exemplary computing device 300, hereinafter interchangeably referred to as a computer system 300, where one or more such computing devices 300 may be used to implement the system 100 of FIG. 1A or the method of FIG. 2. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 318 in a well-known manner. The removable storage medium 318 may include magnetic tape, optical disk, non-volatile memory storage medium, or the like, which is read by and written to by removable storage drive 314. As will be appreciated by persons skilled in the relevant art(s), the removable storage medium 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 320. Examples of a removable storage unit 322 and interface 320 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 320 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the disclosure, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 318, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 320. The computer program product may be a non-transitory computer readable medium. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

FIG. 4 is a schematic of a computing device 400 that may be utilized to implement the payment apparatus 102 shown in FIG. 1.

The computing device 400 comprises a keypad 402, a display 404, a speaker 408 and an antenna 410. Communication hardware that is used to enable NFC communication with the payment card is represented by RF processor 412 which provides an RF signal to the antenna 410 for the transmission of data signals, and the receipt therefrom. Additionally provided is a baseband processor 414, which provides signals to and receives signals from the RF processor 412.

The keypad 402 and the display 404 are controlled by an application processor 418. The keypad 402 can be used to adjust settings for the payment apparatus 102 such as setting the threshold amount. The keypad 402 can also be used to input a transaction amount. The display 404 can be used to provide an indication of the status of the payment apparatus 102, such as payment options available when the payment apparatus 102 detects that it is being used to receive electronic payment or that the payment apparatus 102 is processing payment after a transaction amount is input through the keypad 402. A power and audio controller 420 is provided to supply power to the RF processor 412 and the baseband processor 414, the application processor 418, and other hardware. The power and audio controller 420 also controls audio output via the speaker 408. The speaker 408 can be used to provide sounds to indicate that a data transaction with the payment apparatus 102 has been successfully completed.

In order for the application processor 418 to operate, various different types of memory are provided. First, the computing device 400 includes Random Access Memory (RAM) 426 connected to the application processor 418 into which data and program code can be written and read from at will. Code placed anywhere in RAM 426 can be executed by the application processor 418 from the RAM 426. RAM 426 represents a volatile memory of the computing device 400.

Secondly, the computing device 400 is provided with a long-term storage 428 connected to the application processor 418. The long-term storage 428 comprises three partitions, an operating system (OS) partition 430, a system partition 432 and a user partition 434. The long-term storage 428 represents a non-volatile memory of the computing device 400.

In the present example, the OS partition 430 contains the firmware of the computing device 400 which includes an operating system. Other computer programs may also be stored on the long-term storage 428, such as application programs, and the like. In particular, application programs which are mandatory to the computing device 400 are typically stored in the system partition 432. The application programs stored on the system partition 432 would typically be those which are bundled with the computing device 400 by the device manufacturer when the computing device 400 is first sold. Application programs which are added to the computing device 400 by the user would usually be stored in the user partition 434.

The computing device 400 also comprises an electronic chip sensor 456. The electronic chip sensor 456, together with a suitable application, may be used to detect an electronic chip that is present in conventional credit or debit cards. The electronic chip sensor 456 may have contact pads for reading electronic chips of contact configuration (e.g., those provided on an exposed surface of a payment card) or a wireless transceiver for reading electronic chips of contactless configuration (e.g., those provided within or embedded inside a payment card).

The electronic chip sensor 456, the at least one processor (e.g., application processor 418) and the at least one memory (e.g., RAM 426, long-term storage 428) with its computer program code are configured to cause the payment apparatus 102 at least to receive transaction data relating to a transaction, the transaction data indicating an amount. The at least one memory and the computer program code are further configured to, with the at least one processor, receive, from the payer device, a request to remotely access the transaction, the request including user information verifying the user; enable the payer device to remotely control the transaction in response to receiving the request; receive account information that is remotely input via the payer device, the account information relating to an account to be used for the transaction.

The at least one memory and the computer program code are further configured to, with the at least one processor, cause the payment apparatus 102 to permit the transaction to proceed in response to the determination if the total amount is equal to or less than the threshold amount. This transmission of the data packets may be through the antenna 410 or through a wired data communication port 458.

The payment apparatus 102 of FIG. 1 may execute the method shown in FIG. 2 for enabling a payer device for effecting a transaction. This method comprises, at step 202, receiving, from the payer device, a request to remotely access the transaction, the request including user information verifying the user. The method further comprises, at step 204, enabling, the payer device, to remotely control the transaction in response to receiving the request. The method further comprises, at step 206, receiving account information that is remotely input via the payer device, the account information relating to an account to be used for the transaction.

The payment apparatus 102 executes instructions which may be stored in any one or more of the RAM 426 or the long-term storage 428. These components 426 and 428 provide a non-transitory computer readable medium having stored thereon executable instructions for controlling the payment apparatus 102 to perform steps comprising: a) receiving, from the payer device, a request to remotely access the transaction, the request including user information verifying the user; b) enabling, the payer device, to remotely control the transaction in response to receiving the request; and c) receiving account information that is remotely input via the payer device, the account information relating to an account to be used for the transaction.

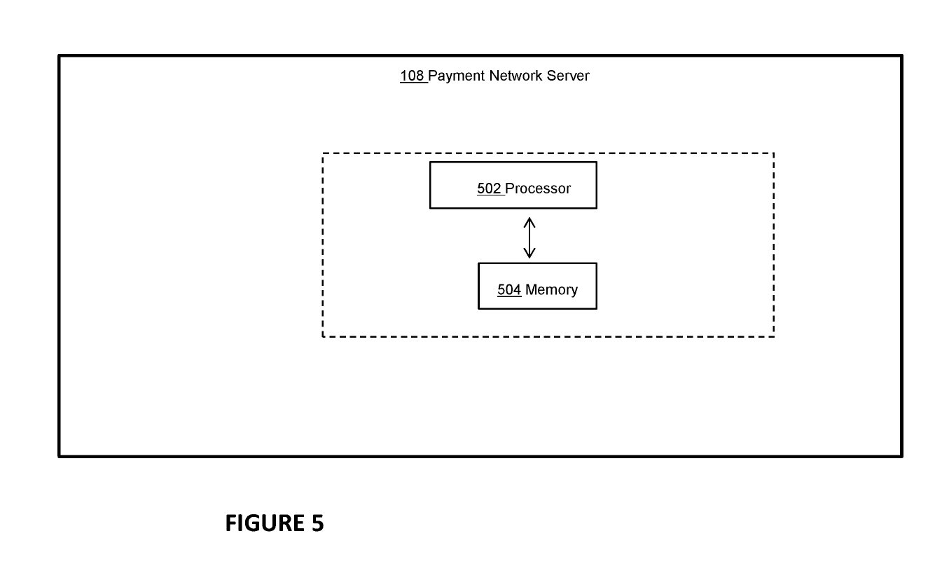

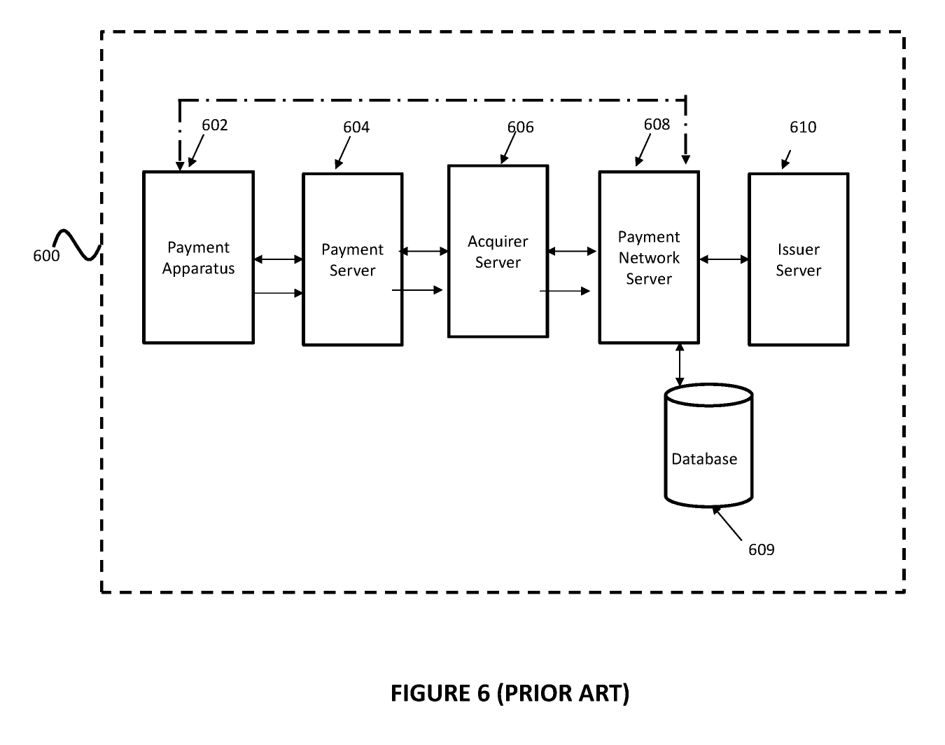

In an implementation, the payment network server 108 may be generally described as a physical device comprising at least one processor 502 and at least one memory 504 including computer program code. The at least one memory 504 and the computer program code are configured to, with the at least one processor 502, cause the physical device to perform the operations described in FIG. 1. An example of the payment network server 108 is shown in FIG. 5.

As mentioned in the above, conventionally, a payment apparatus 602 is one that is configured to the payment server 604. The conventional payment apparatus 602 only allows one customer to make payment at any point in time. Moreover, for customers to key in their passwords at the payment apparatus 602, may not seem to be secure because customers standing behind them may be able to view these passwords which may be saved in a database 609. The details that are entered at the payment apparatus 602 may be sent to the payment server 604 before they are forwarded to the payment network server 608 via the acquirer server 606 to facilitate payment with the issuer server 610. There are various problems with this conventional payment apparatus 602. For one, for customers to key in their passwords at the payment apparatus 602 may not seem to be secure because customers standing behind them may be able to view these passwords.

It will be appreciated by a person skilled in the art that numerous variations and/or modifications may be made to the present disclosure as shown in the specific embodiments without departing from the spirit or scope of the disclosure as broadly described. For example, the above description mainly discusses the use of a Bluetooth connection, but it will be appreciated that another type of secure wireless connection, such as Wi-Fi, can be used in alternate embodiments to implement the method. Some modifications, e.g., adding an access point, changing the log-in routine, etc. may be considered and incorporated. The present embodiments are, therefore, to be considered in all respects to be illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A payment apparatus for enabling a payer device for effecting a transaction, the payer device operationally communicable with the payment apparatus, the payment apparatus comprising:
at least one processor; and
at least one memory including computer program code;
the at least one memory and the computer program code configured ROM with the at least one processor, to cause the payment apparatus to:
receive, from the payer device, a request to remotely access the transaction, the request including user information verifying the user;
enable the payer device to remotely control the transaction in response to receiving the request; and
receive account information that is remotely input via the payer device, the account information relating to an account to be used for the transaction.

2. The payment apparatus according to claim 1, wherein the at least one memory and the computer program code are configured ROM with the at least one processor, to further cause the payment apparatus to:
receive, from a further payer device, a further request to remotely access a further transaction initiated by the further payer device, the further request being one that is received while the payment apparatus is enabling the further payer device to remotely control the further transaction.

3. The payment apparatus according to claim 1, wherein the at least one memory and the computer program code are configured ROM with the at least one processor, to further cause the payment apparatus to:
receive, from the payer device, authentication information authenticating if the user using the payer device is an owner of the account.

4. The payment apparatus according to claim 1, wherein the at least one memory and the computer program code are configured ROM with the at least one processor, to further cause the payment apparatus to:
wirelessly receive, from the payer device, a remote input signal when enabling the payer device to remotely control the transaction.

5. The payment apparatus according to claim 1, wherein the at least one memory and the computer program code are configured ROM with the at least one processor, to further cause the payment apparatus to:
receive, from a payment network server, an offer available to the payer; and
forward, to the payer device, the offer.

6. The payment apparatus according to claim 5, wherein the at least one memory and the computer program code are configured ROM with the at least one processor, to further cause the payment apparatus to:
receive, from the payer device, a request to utilize the offer available to the payer.

7. The payment apparatus according to claim 1, wherein the at least one memory and the computer program code are configured ROM with the at least one processor, to further cause the payment apparatus to:
receive, from a server, a transaction receipt in response to an approval of the transaction, the transaction receipt indicating at least a name of a product and a corresponding transaction amount of the product; and
send, to the payer device, the transaction receipt.

8. The payment apparatus according to claim 1, wherein the payment apparatus is not in internet communication with the payer device.

9. The payment apparatus according to claim 1, wherein the payment apparatus is a payment server.

10. A computer-implemented method for enabling a payer device for effecting a transaction, the method comprising:
receiving, by a payment apparatus computing device, from the payer device, a request to remotely access the transaction, the request including user information verifying the user;
enabling, by the payment apparatus computing device, the payer device, to remotely control the transaction in response to receiving the request;
receiving, by the payment apparatus computing device, account information that is remotely input via the payer device, the account information relating to an account to be used for the transaction.

11. The method according to claim 10, further comprising receiving, by the payment apparatus computing device, from a further payer device, a further request to remotely access a further transaction initiated by the further payer device, the further request being one that is received while the payment apparatus computing device is enabling the further payer device to remotely control the further transaction.

12. The method according to claim 10, further comprising receiving, by the payment apparatus computing device, from the payer device, authentication information authenticating if the user using the payer device is an owner of the account.

13. The method according to claim 10, further comprising wirelessly receiving, by the payment apparatus computing device, from the payer device, a remote input signal when enabling the payer device to remotely control the transaction.

14. The method according to claim 10, further comprising:
receiving, by the payment apparatus computing device, from a payment network server, an offer available to the payer; and
forwarding, by the payment apparatus computing device, to the payer device, the offer.

15. The method according to claim 14 further comprising receiving, by the payment apparatus computing device, from the payer device, a request to utilize the offer available to the payer.

16. The method according to claim 10, further comprising:
receiving, by the payment apparatus computing device, from a server, a transaction receipt in response to an approval of the transaction, the transaction receipt indicating at least a name of a product and a corresponding transaction amount of the product; and
sending, by the payment apparatus computing device, to the payer device, the transaction receipt.

17. The method according to claim 10, wherein the request to remotely access the transaction is received from the payer device when the payer device is not in internet communication with the payment apparatus computing device.
